(19) United States
(12) Patent Application Publication
(10) Pub. No.: US 2012/0091290 A1
(43) Pub. Date: Apr. 19, 2012

(54) LOCK STRUCTURE FOR WIRE HARNESS PROTECTOR

(75) Inventor: Masaru Shitamichi, Yokkaichi-city (JP)

(73) Assignee: SUMITOMO WIRING SYSTEMS, LTD., Yokkaichi-city, Mie (JP)

(21) Appl. No.: 13/379,918

(22) PCT Filed: Feb. 24, 2010
(86) PCT No.: PCT/JP2010/052813

§ 371 Date: Dec. 21, 2011

(30) Foreign Application Priority Data
Jul. 30, 2009 (JP) 2009-178436

(51) Int. Cl. F16L 3/10

(52) U.S. Cl. 248/65

(57) ABSTRACT

In a lock structure including a main body and a lid for a protector, a reduction in insertion force is achieved while maintaining gripping force. A female lock part is provided in which both side frames protruding from the outer surface of a lateral wall of a protector main body are linked by a latching frame. The female lock part includes a gap with the outer surface of the lateral wall. The lid is provided with a male lock part including a latching tab on which a latching claw protrudes. The thickness of the latching tab is smaller than the measurement of the gap of the female lock part and also has a circular arc shape, imparting elasticity. When the male lock part passes into the gap of the female lock part, the insertion force is reduced by warping the latching tab.

### FIELD OF THE INVENTION

The present invention relates to a lock structure for a wire harness protector. More particularly, in a protector through which a wire harness has been inserted, the protector guiding and protecting the wire harness routed in an automobile, when a lid is capped on a main body of the protector for lock connection, the present invention achieves reduction of the insertion force of a lock tab.

### BACKGROUND OF THE INVENTION

As the lock structure for this type of protector, for example, the lock structure in Japanese Patent Laid-open Publication 2005-160222 illustrated by FIGS. 10(A) and 10(B) has been suggested. In the lock structure, a female lock part 101 protrudes from an outer surface of a lateral wall 100a on a protector main body 100, and a male lock part 111 protrudes downward from the outer surface of a circumferential wall of a lid 110. The female lock part 101 has a squared U-shaped frame with both side walls 101a, which protrude out from the lateral wall 100a, and a latching beam 101b, which connects both side walls 101a. The female lock part 101 is provided with a rectangular gap C between the female lock part 101 and an outer wall 100a. On the other hand, on the male lock structure 111, a latching claw 111b protrudes in an outward orientation in the center of the lower end of a latching tab 111a, which has a size which engages with the gap C. The latching claw 111b has a shape having a tapered portion 111b1 sloped in an upward orientation from the lower end and a main body portion 111b2 of a uniform thickness provided at the upper portion of the tapered portion 111b1.

After the wire harness is inserted into the protector main body 100, the lid 110 is capped onto it, joining and locking with the main body 100, whereupon the latching tab 111a of the male lock part 111 is pressure-fitted into the gap C of the female lock part 101. At that point, due to the latching claw 111b protruding, it causes the latching tab 111a and the latching beam 101b of the female lock part 101 to warp. The latching claw 111b then passes into the gap C of the female lock part 101 and is latched on the lower surface of the latching beam 101b.

### RELATED ART

### Patent Literature

Japanese Patent Laid-open Publication 2005-160222

### SUMMARY OF THE INVENTION

### Problems to be Solved by the Invention

In the lock structure illustrated in FIGS. 10(A) and 10(B) described above, after the male lock part and the female lock part are joined and locked, in order to eliminate rattling of the lock parts, the relationship of a plate thickness t10 of the latching tab 111a on the male lock part 111 to a width w10 of the gap C is configured to be t10≦w10, and preferably configured to be t10=w10. It is preferable that at the time of joining and locking, both the inner and outer surfaces of the latching tab 111a make surface contact with both the outer surface of the protector main body 100 and with the inner surface of the latching beam 101b. However, when attempting to eliminate the occurrence of rattling with the measurement configuration described above, because the latching claw 111b protrudes further still from the latching tab 111a, the amount of warp of the latching beam 101b may become large when the latching claw 111b is inserted into the gap C and the insertion force may become elevated. An operator performs the operation of capping the lid 110 onto the protector main body 100 to press-fit the latching tab 111a beginning with the latching claw 111b on its lower end into the gap C of the female lock part and, because the latching tab 111a is small, the operation load on the operator may increase.

The present invention aims to resolve this situation and has its advantage eliminating rattling without generating clearance between the latching tab of the male lock part in the gap of the female lock part after they have been joined and locked, and also reducing the burden on the operator by making the insertion force of the male lock part during joining and locking not become elevated.

### Means for Solving the Problems

In order to resolve the above situation, the present invention provides a lock structure for a wire harness protector formed from resin-molded objects including a main body having a bottom wall and lateral walls, and also having a female lock part protruding from the outer surface of a lateral wall, and a lid having a male lock part, which engages the female lock part, protruding from one of a top wall and a lateral wall. The female lock part includes frames on both sides protruding from the outer surface of the lateral wall and a latching frame connecting measurement between the latching frame and the outer surface of the side wall is L1. The male lock part includes a latching tab and a latching claw provided in a center of a lower portion of the latching tab. The thickness in a width direction of the latching tab is smaller than the measurement L1 of the gap. In addition, as well as curving in a left-right direction orthogonal to the width direction, the latching tab also has a circular arc shape protruding outward at a center in the left-right direction, and is thin at a center where the latching claw protrudes and thick at both left-right ends. Further, when the latching claw is passed into the gap of the female lock part, the latching tab warps then, in a state in which the latching claw protrudes from the gap and is latched on a lower surface of the latching frame, the latching tab reverts to its original shape. In addition, as well as an outer surface of the center of the latching tab contacting an inner surface of the latching frame, inner surfaces of both side ends of the latching tab contact the lateral wall.

As described above, the female lock part has a squared U-shaped frame composed of frames on both sides and a latching frame, and includes a gap with an outer wall of the main body through which the male lock part is inserted. In addition to making the thickness of the latching tab of the male lock part thinner than the width-direction measurement of the gap, the latching tab has a circular arc shape, giving the latching tab elasticity. Accordingly, when the latching claw passes through the gap of the female lock part and the latching claw is pressed by the latching frame, the latching tab warps, and it is possible to reduce the protrusion amount of the latching claw, and also possible to achieve reduction of the insertion force of the male lock part. Also, when the latching claw is separated from the latching frame, the latching tab elastically reverts to its original shape and the center of the outer peripheral surface protruding outward from the latching tab is able to make direct contact with the inner surface of the latching frame, as well as both sides of the latching tab being able to make direct contact with the outer surface of the main body lateral wall. In addition, it is possible for the latching tab to engage the gap without rattling, as well as not causing a reduction in the gripping force of the latching claw even when the latching tab is thin.

Depending on the conditions for the vehicle in which the protector is equipped, the protrusion amount of the female lock part from the outer surface of the lateral wall of the main body is confined, and the width of the gap of the female lock part changes based thereon. In response to the width of the gap of the female lock part, by adjusting the curvature of the latching tab, in the lock position it is possible for the center of the outer peripheral surface of the latching tab to accurately make direct contact with the inner surface of the latching frame of the female lock part and for both side portions of the latching tab to accurately make direct contact with the outer surface of the lateral wall of the main body.

As described above, for the thickness of the latching tab, the central portion at which the latching claw protrudes is thin and both the left and right ends are thick. Taking the above-described configuration, when the male lock part has passed through the gap of the female lock part, upon press-fitting the latching tab into the latching frame, by making the thickness of the press-fitted portion thin, it is possible to better facilitate warping of the latching tab.

In the female lock part, it is preferable that in addition to including a notch beginning at the upper end on the inner surface side of the latching frame, a notch is also included on the lateral wall at the opposing position to widen the insertion opening of the gap. Taking this configuration, it is possible to smoothly insert the latching claw from the insertion opening of the gap of the female lock part.

The protector of the present invention may be integrally formed of the main body and the lid, or the main body and the lid may be separate. That is, a thin-walled hinge may be provided between one lateral wall of the main body and the lid to form a single body, the female lock part then provided on the other lateral wall of the main body and the male lock part provided on the lid in a position opposite to the female lock part. Alternatively, the main body and the lid of the protector may be separate, the female lock part then provided on both lateral walls of the main body and the male lock part provided on both sides of the lid.

### Effect of the Invention

As described above, in a lock structure in which the male lock part provided on the lid is inserted and latched into the female lock part provided on the main body of the protector, the thickness of the latching tab on the male lock part is thinner than the measurement of the gap between the latching frame on the female lock part and the outer surface of the main body lateral wall opposite, and the latching tab has a circular arc shape, imparting elasticity. Accordingly, when the latching claw which protrudes from the outer surface of the latching tab passes through the gap of the female lock part, upon press-fitting the latching claw into the latching frame, the latching tab warps and therefore it is possible to reduce the protrusion amount of the latching claw, and it is possible to achieve a reduction of the insertion force. Also, after passage of the latching claw through the latching frame, the latching tab elastically reverts and it is possible for the latching tab to contact the inner surface of the latching frame and the outer surface of the main body lateral wall with no clearance, and it is possible to eliminate rattling of the latching tab and to increase the gripping force of the latching claw.

### BRIEF DESCRIPTION OF THE DRAWINGS

FIGS. 1(A)-1(C) illustrate a protector according to the first embodiment, FIG. 1(A) being a partial perspective view when the lid is in an open state; FIG. 1(B) being a partial perspective view when the lid is in a closed state; and FIG. 1(C) being a full perspective view when the wire harness is in an inserted state;

FIGS. 2(A) and 2(B) illustrate a female lock part on the main body side of the protector, FIG. 2(A) being a plan view; and FIG. 2(B) being a cross-sectional view along a line B-B of FIG. 2(A);

FIGS. 3(A)-3(C) illustrate a male lock part on the lid side of the protector, FIG. 3(A) being a perspective view; FIG. 3(B) being a cross-sectional view along a line B-B of FIG. 3(A); and FIG. 3(C) being a cross-sectional view along a line C-C of FIG. 3(A);

FIGS. 4(A) and 4(B) illustrate a state prior to insertion of the male lock part into the female lock part, FIG. 4(A) being an exploded explanatory view in a vertical direction; and FIG. 4(B) being an exploded explanatory view in a horizontal direction;

FIGS. 5(A) and 5(B) illustrate a state at the time of insertion of the male lock part into the female lock part, FIG. 5(A) being an explanatory view in a vertical direction; and FIG. 5(B) being an explanatory view in a horizontal direction;

FIGS. 6(A) and 6(B) illustrate a state in which the male lock part is joined and locked with the female lock part, FIG. 6(A) being an explanatory view in a vertical direction; and FIG. 6(B) being an explanatory view in a horizontal direction;

FIGS. 7(A) and 7(B) are cross-sectional views illustrating alternative examples of the latching tab of the male lock part, and FIG. 7(C) is a cross-sectional view illustrating a reference alternative example;

FIGS. 8(A)-8(C) illustrate a reference second embodiment, FIG. 8(A) being a perspective view illustrating the male lock part provided on the lid; FIG. 8(B) being an explanatory view of a lock state; and FIG. 8(C) being a cross-sectional view of the female lock part;

FIG. 9 is a summarized exploded perspective view of a third embodiment; and

FIGS. 10(A) and 10(B) are views illustrating conventional examples.

### MODE FOR CARRYING OUT THE INVENTION

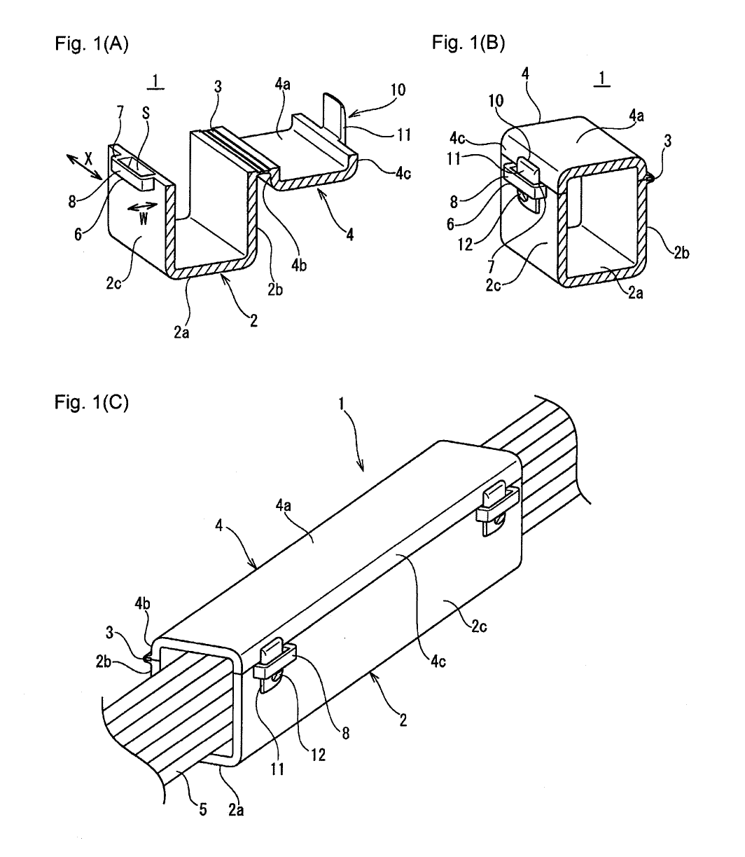

Hereafter, embodiments of the present invention are explained with reference to the drawings. FIGS. 1(A)-6(B) illustrate a first embodiment. In a protector 1 of the first embodiment, a main body 2 and a lid 4 are integrally formed of resin via a thin-walled hinge 3. The main body 2 has a concave shape in cross-section having a bottom wall 2a, and lateral walls 2b and 2c vertically provided from both ends in a width direction of the bottom wall 2a. The lid 4 connects so as to be freely openable and closable with the front end of the lateral wall 2b via the thin-walled hinge 3 and, as shown in FIG. 1(C), after a wire harness 5 has been inserted in the main body 2, the lid 4 is capped onto it, sealing the upper surface opening of the main body 2.

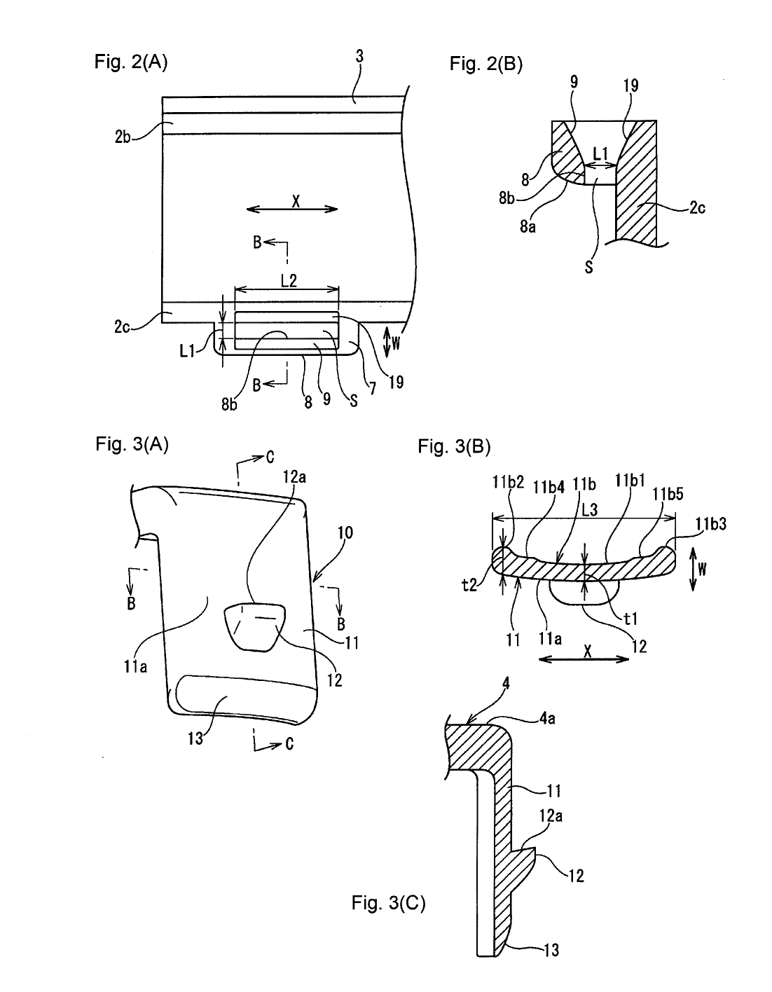

On the outer surface of the lateral wall 2c of the main body, from an upper end downward, a female lock part 6 is provided. The female lock part 6 includes a gap S in a squared U-shape having a front-back pair of side frames 7, 7 protruding from the outer surface of the lateral wall 2c and a latching frame 8 connecting the protruding ends of both side frames 7, 7. The gap S is sealed between the female lock part 6 and the lateral wall 2c. Further, as shown in FIGS. 2(A) and 2(B), on the upper portion of the inner surface side of the latching frame 8, a notch 9 is provided having a shape tapered from the upper end edge toward the gap S, and in addition a notch 19 having a target shape is provided from an upper end of the lateral wall 2c in a position opposite to the notch surface 9, widening the insertion opening of the gap S. A measurement in a width direction W of the gap S is gradually narrowed such that a measurement in the width direction W at a lower portion not provided with notches 9 and 19 is L1. Also, a measurement in a left-right direction X orthogonal to the width direction is L2.

The lid 4 includes a top wall 4a and lateral walls 4b and 4c protruding from both ends in a width direction of the top wall 4a. The lateral wall 4b is connected to the lateral wall 2b of the main body 2 via the thin-walled hinge 3. The lateral wall 4c is the opening and closing side. A male lock part 10 protrudes from the lower end of the lateral wall 4c in a position opposite to the female lock part 6.

The male lock part 10 has a latching tab 11 and a latching claw 12 protruding from the outer surface at the center of the lower portion of the latching tab 11. The latching tab 11 is press-fitted from the latching claw 12 side into the gap S of the female lock part 6, being joined and locked by the latching claw 12 latching on the lower surface 8a of the latching frame 8 as well as the latching claw 12 being gripped by the latching tab 11 being engaged within the gap S.

The thickness of the latching tab 11 is smaller than the measurement L1 in the width direction of the gap S, and the central portion in the left-right direction X has a circular arc shape curved such that it protrudes outward, imparting elasticity. The outer peripheral surface 11a of the latching tab 11, which has a circular arc shape, makes a circular arced surface continuing at a desired curvature and the latching claw 12 protrudes at a lower portion of the central portion, which protrudes outward. The inner peripheral surface 11b of the latching tab 11 includes unevenness in a left-right direction, where the central portion is the portion with the least thickness 11b1 and both left-right end portions are the portions with the greatest thickness 11b2 and 11b3. Portions with intermediate thickness 11b4 and 11b5 are provided between the portion with the least thickness 11b1 and the portions with the greatest thickness 11b2 and 11b3, respectively.

A thickness measurement t2 for the portions with the greatest thickness 11b2 and 11b3 is approximately 70% of the measurement L1 for the gap S, and a thickness measurement t1 for the portion with the least thickness 11b1 is approximately 30% of the measurement L1 for the gap S. A measurement L3 linked by a straight line both ends in a left-right direction of the latching tab 11, which has a circular arc shape, is smaller than the measurement L2 for the gap S. The measurement L3 also includes a difference in measurement allowing the curvature of the circular arc of the circular arc-shaped latching tab 11 to warp such that it grows larger and spreads to the left and right.

In the latching tab 11, in a lock state in which the latching claw 12 is latched on the lower surface 8a of the latching frame 8, the curvature of the circular arc shape is configured such that the portion of the outer peripheral surface 11a protruding furthest outward makes line contact with the inner surface 8b of the latching frame 8 and such that the inner surface of the portions with the greatest thickness 11b2 and 11b3 on the left-right ends contact the lateral wall 2c of the main body.

The latching claw 12 provided in the center of the lower portion of the latching tab 11 protrudes upward, sloping from the bottom end, and the latching surface 12a of the upper end surface has a flat surface. In addition, the latching surface 12a may have a reverse taper shape toward the latching tab 11 and which increases the gripping force.

A sloped portion 13 is further provided with a gradually thinning thickness from a position below the latching claw 12 toward the lower end of the latching tab 11, which acts as the insertion side front end.

The female lock part 6 provided on the main body 2 and the male lock part 10 provided on the lid 4, as shown in FIG. 1(C), are provided on both end sides in a length direction of the protector 1. In a case where the protector 1 is elongated or bent, the female lock part 6 and the male lock part 10 are also provided on a central portion in the length direction.

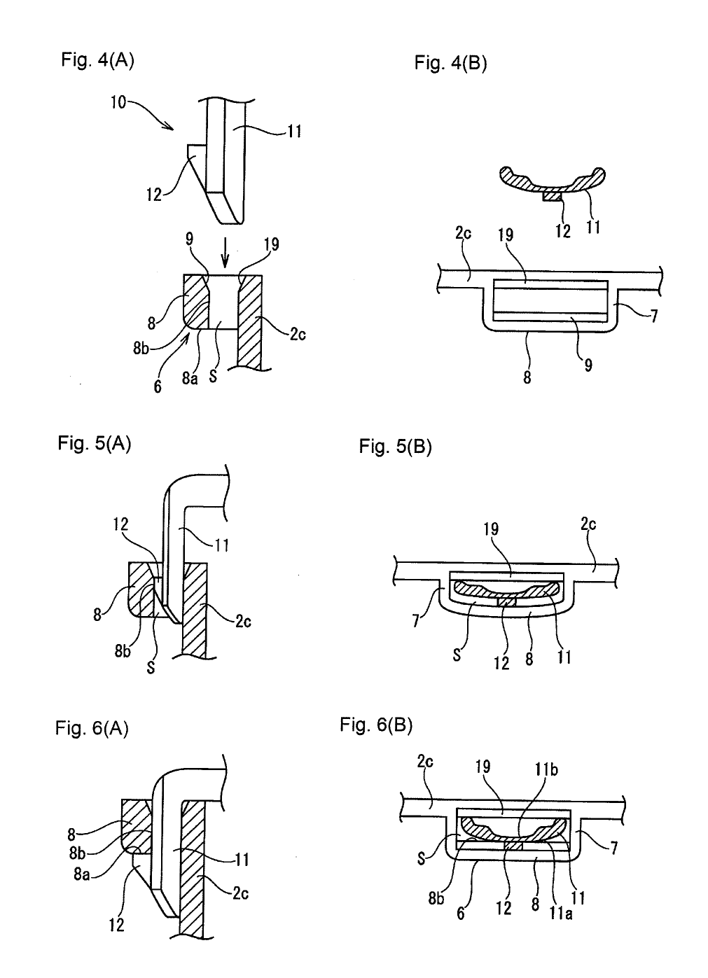

In the protector 1 formed with the configuration described above, in a state where the lid 4 is open, the wire harness 5 is inserted into the main body 2 and, after insertion, the lid 4 is rotated in a sealing direction with the thin-walled hinge 3 as a pivot. In the rotation operation, the male lock part 10 on the lid 4 is positioned above the female lock part 6 on the main body 2, as shown in FIGS. 4(A) and 4(B). In this position, by pressing the lid 4 down, the lower end of the latching tab 11 of the male lock part 10 is inserted into the gap S of the female lock part 6. During insertion, because the lower edge of the latching tab 11 is provided with a sloped portion 13, it is possible to perform smooth insertion into the gap S.

When the latching claw 12 reaches the upper end insertion opening of the gap S, because it is widened by inclusion of the notches 9 and 19 on both sides and because the lower portion of the latching claw 12 is sloped, the latching claw 12 is able to be inserted into the gap S comparatively smoothly. After the latching claw 12 has passed between the notches 9 and 19, as shown in FIGS. 5(A) and 5(B), when the latching claw 12 reaches the portion of the measurement L1 where the width is narrowest, it is necessary to increase the insertion force. At that point, because elasticity is imparted with the thickness of the latching tab 11 being thin as well as with a circular arc shape, and in particular because the portion from which the latching claw 12 protrudes is the portion with the least thickness 11b1, when the latching claw 12 is press-fitted on the inner surface 8b of the latching frame 8, as shown in FIG. 5(B), the circular arc curvature of the latching tab 11 warps such that it grows larger and spreads in a left-right direction. Because the protrusion amount of the latching claw 12 is reduced thereby, it is also possible to reduce the outward warping amount of the latching frame 8 and to reduce the amount of increase in the insertion force.

When the latching claw 12 passes the latching frame 8 and separates from the latching frame 8 by pushing in the male lock part 10, as shown in FIGS. 6(A) and 6(B), the warped latching tab 11 elastically reverts and the latching claw 12 protrudes outward, and the latching surface 12a on the upper end of the latching claw 12 latches on the lower surface 8a of the latching frame 8. In addition, for the latching tab 11 which has reverted to its original shape, the central portion in the left-right direction with the greatest outward protrusion on the outer peripheral surface 11a makes line contact with the inner surface 8b of the latching frame 8. In addition, the portions with the greatest thickness 11b2 and 11b3 on both left-right ends of the inner peripheral surface 11b of the latching tab 11 contact the outer surface of the lateral wall 2c of the main body 2. In this way, the central portion of the outer peripheral surface 11a of the latching tab 11 and both side portions of the inner peripheral surface 11b are able to contact the latching frame 8 and the lateral wall 2c with no clearance. Accordingly, it is possible to prevent rattling of the latching tab 11 within the gap S as well as to prevent a reduction in engagement force within the gap S even when the latching tab 11 is thin.

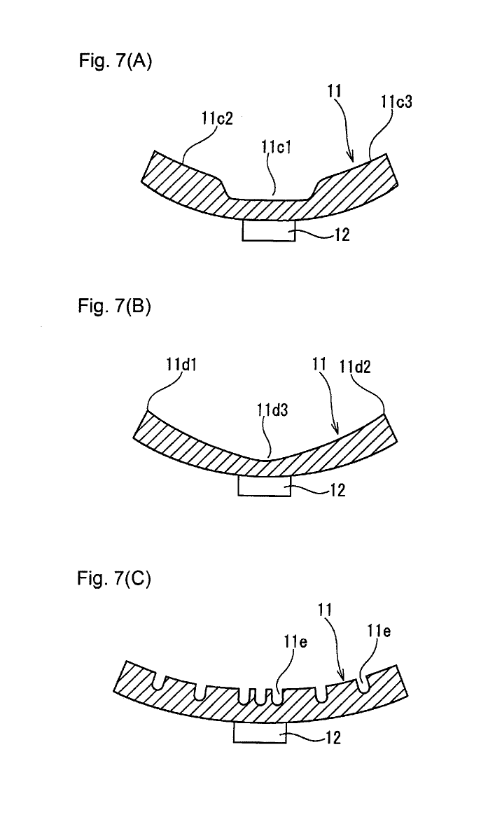

FIGS. 7(A) and 7(B) show alternative examples of the latching tab 11. In FIG. 7(A), the latching tab 11 does not include a portion of intermediate thickness, provided with a thin portion 11c1 in the center of the portion on which the latching claw 12 is provided, and is provided with thick portions 11c2 and 11c3 on both sides thereof. In FIG. 7(B), the portions with the greatest thickness on both left-right ends are 11d1 and 11d2, and the portion with the least thickness 11d3 is the central position. The thickness decreases continuously from both left-right ends toward the center. FIG. 7(C) illustrates a reference example, and provides U-shaped grooves 11e on the inner peripheral surface 11b of the latching tab 11, providing a plurality of the groove 11e on the central portion, and reducing the number of grooves 11e toward both left-right ends. Accordingly, the latching claw 12 portion warps back the easiest. For any of the alternative examples, when the latching claw 12 is pressed to the latching frame 8, the latching tab 11 easily warps.

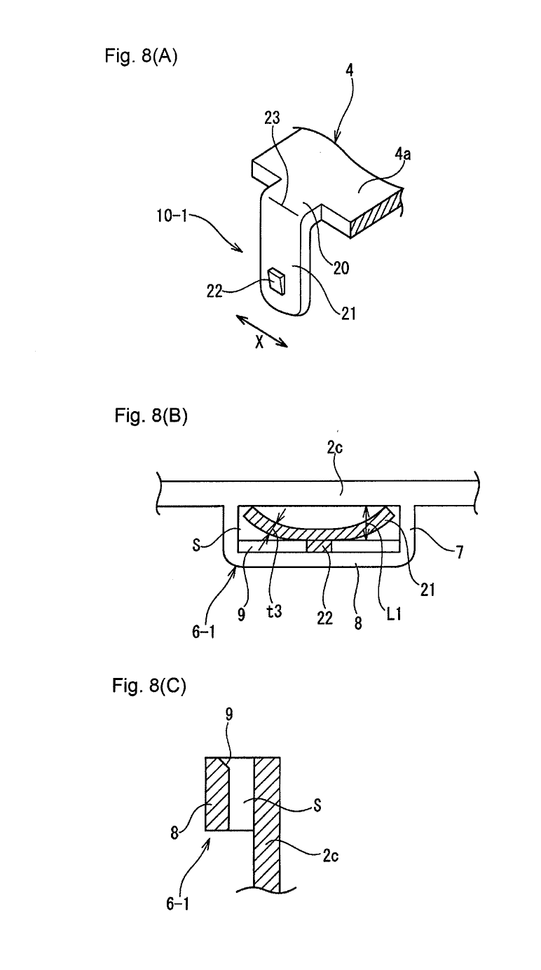

A reference second embodiment is shown in FIGS. 8(A)-8(C). In the reference second embodiment, a peripheral wall is not provided from the top wall 4a on the opening and closing end side of the lid 4, but rather a male lock part 10-1 protrudes in an L-shape from the end edge of the top wall 4a. Specifically, a latching tab 21 protrudes downward from the front end of a horizontal support portion 20, which is continuous with the top wall 4a, and a latching claw 22 protrudes from the outer surface of the center of the lower portion of the latching tab 21. A connector portion 23 between the support portion 20 and the latching tab 21 has the shape of a straight line in a left-right direction. The latching tab 21 has a circular arc shape bending gradually in a left-right direction X toward the bottom. A portion provided with the latching claw 22 has a circular arc shape having a curvature similar to the first embodiment. As shown in FIG. 8(B), the latching tab 21 has a uniform thickness t3, and no unevenness is provided on the inner peripheral surface side. The thickness t3 is equal to the portion of intermediate thickness in the first embodiment, and is approximately 30-40% of the width measurement L1 of the gap S of a female lock part 6-1.

On the other hand, the female lock part 6-1 provided on the main body 2 opposite to the male lock part 10-1 is not provided with a notch on the lateral wall 2c of the main body 2. Other structures are similar to the first embodiment and thus identical reference numerals are used and their explanation is omitted.

As described above, the thickness t3 of the latching tab 21 is uniform; however, because it is thinner than the measurement L1 of the gap S of the female lock part 6-1, and also because it has a circular arc shape, the latching tab 21 has elasticity. Accordingly, when the latching claw 22 passes through the gap S, upon the latching tab 21 being pressed by the latching frame 8, the latching tab 21 warps such that it spreads out similarly to the first embodiment and the amount of protrusion of the latching claw 22 is reduced, and it is possible to achieve a decrease in insertion force. Also, the connector portion 23 between the latching tab 21 and the support portion 20 has a straight line portion rather than a circular arc shape, and therefore when the curvature of the circular arc of the latching tab 21 grows bigger and spreads to the left and right, there is no resistance from the connector portion 23 and it is able to warp smoothly.

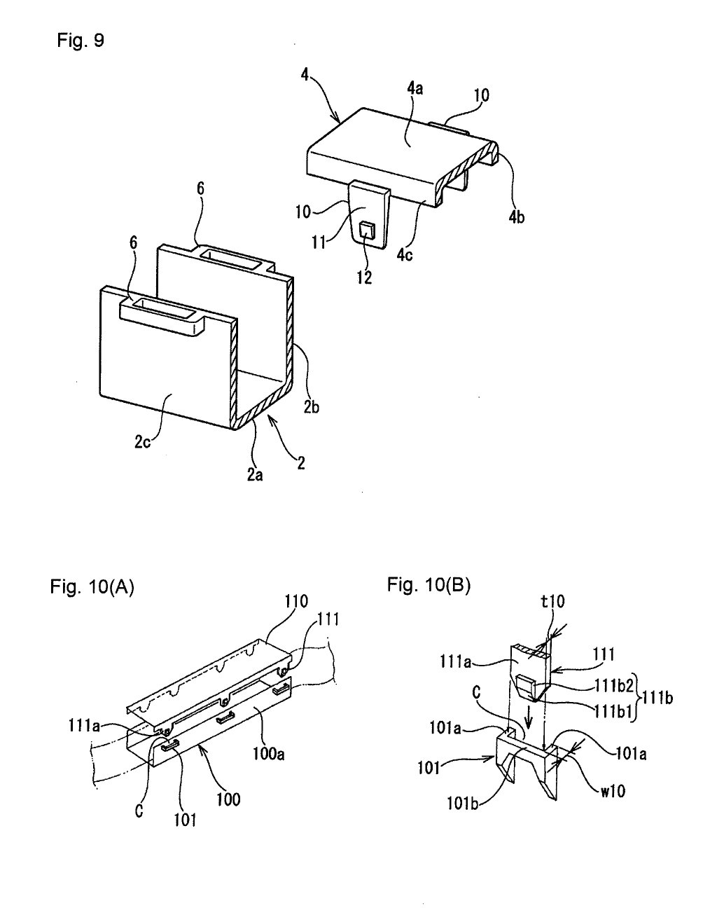

FIG. 9 shows a protector according to a third embodiment. In the protector 1, the main body 2 and the lid 4 are separate, and the protector includes female lock parts 6, 6 on both lateral walls 2b and 2c of the main body 2. The lid 4 includes male lock parts 10, 10 on both lateral walls 4b and 4c on the top wall 4a. The shapes of the female lock parts 6, 6 and of the male lock parts 10, 10 are identical to the first embodiment, and the male lock part 10 includes the latching tab 11 having a circular arc shape. The latching claw 12 protrudes from the latching tab 11. Other structures are also similar to the first embodiment. Moreover, the structures may have similar to the alternative examples illustrated in FIGS. 7(A)-7(C).

In the protector 1, after a wire harness is passed into the main body 2, the lid 4 is capped over it and the male lock parts 10 are inserted into the female lock parts 6 on both sides in a width direction. Similarly to the first embodiment, the latching tab 11 warps during insertion, and it is possible to reduce the insertion force. In addition, by the latching tab 11 reverting to its original shape in a lock state in which the latching claw 12 is latched on the lower surface of the latching frame 8, it is also possible to not reduce the gripping force of the latching claw 12 by contact with the inner surface of the latching frame 8 and the lateral walls 2b and 2c, as well as to eliminate the occurrence of rattling.

1. A lock structure for a wire harness protector formed of molded resin, comprising:
a main body having a bottom wall, lateral walls, and a female lock part protruding from the outer surface of a lateral wall; and
a lid having a male lock part configured to engage the female lock part, the male lock part protruding from one of a top wall and a lateral wall of the lid, wherein:
the female lock part comprises frames on both sides protruding from the outer surface of the lateral wall and a latching frame connecting distal ends of both side frames, and has a gap in a width direction between the latching frame and the outer surface of the lateral wall of distance L1,
the male lock part comprises a latching tab and a latching claw provided in a center of a lower portion of the latching tab, the thickness in a width direction of the latching tab being smaller than the distance L1 of the gap, the latching tab curving in a left-right direction orthogonal to the width direction, the latching tab also having a circular arc shape protruding outward at a center in the left-right direction, and being thin at a center where the latching claw protrudes and thick at both left-right ends, and
in a condition in which the latching claw is passed into the gap of the female lock part, the latching tab warps, and in a condition in which the latching claw protrudes from the gap and is latched on a lower surface of the latching frame, the latching tab reverts to its original shape, an outer surface of the center of the latching tab contacting an inner surface of the latching frame, and inner surfaces of both side ends of the latching tab contact the lateral wall.

2. (canceled)

3. The lock structure for a wire harness protector according to claim 1, wherein the female lock part is provided with a notch beginning at an upper end on the inner surface side of the latching frame, and a notch is provided on a lateral wall at an opposing position to widen the insertion opening of the gap.

4. The lock structure for a wire harness protector according to claim 1, wherein ene-ef the protector is a single body provided with a thin-walled hinge between one lateral wall of the main body and the lid, the female lock part is provided on the other lateral wall of the main body, and the male lock part is provided on the lid at a position opposite to the female lock part.

5. The lock structure for a wire harness protector according to claim 1, wherein the main body and the lid of the protector are separate, the female lock part provided on both lateral walls of the main body, and the male lock part provided on both sides of the lid.

6. The lock structure for a wire harness protector according to claim 3, wherein the protector is a single body provided with a thin-walled hinge between one lateral wall of the main body and the lid, the female lock part is provided on the other lateral wall of the main body, and the male lock part is provided on the lid at a position opposite to the female lock part.

7. The lock structure for a wire harness protector according to claim 3, wherein the main body and the lid of the protector are separate, the female lock part provided on both lateral walls of the main body, and the male lock part provided on both sides of the lid.
